(19) United States
(12) Patent Application Publication
(10) Pub. No.: US 2026/0343138 A1
(43) Pub. Date: Oct. 29, 2026

(54) FORCE-CANCELING COAXIAL SPEAKER SYSTEM WITH ACOUSTIC APERTURE

(71) Applicant: Atieva, Inc., Newark, CA (US)

(72) Inventors: Timothy Sandrik, Walnut Shade, MO (US); Tanmy Parshuram Srivastave, Fremont, CA (US); Ryan Mihelich, Morgan Hill, CA (US)

(21) Appl. No.: 19/189,925

(22) Filed: Apr. 25, 2025

(51) Int. Cl. H04R 1/28; H04R 1/02

(52) U.S. Cl. CPC H04R 1/2873; H04R 1/025; H04R 2499/13

(57) ABSTRACT

A force-canceling coaxial speaker system comprises: a speaker cabinet defining an interior; a first midrange speaker mounted inside the speaker cabinet; a second midrange speaker mounted inside the speaker cabinet, the first midrange speaker and the second midrange speaker having a common size; an acoustic aperture in the speaker cabinet, the acoustic aperture forming an opening from the interior having an area that is proportional to a speaker displaced volume of the first and second midrange speakers by a factor of about 80-160 by unit length; and a high-frequency transducer mounted adjacent the acoustic aperture.

### TECHNICAL FIELD

This document relates to a force-canceling coaxial speaker system with an acoustic aperture.

### BACKGROUND

Vehicles are equipped with audio systems to provide infotainment, including to play entertainment for the occupants and to output content relating to the operation of the vehicle (e.g., navigation instructions or alerts). Modern vehicles tend to include many components made of lightweight materials, and mounting loudspeakers to or near such structures can cause unwanted buzzing or vibrations. This can be particularly noticeable in vehicles with electric drivetrains which typically provide a much quieter experience for the occupants than older types of vehicles. Attempts to address these problems have been made, including by adding foam, tape or other materials that dampen vibrations, which adds cost and complicates the assembly, or by minimizing the amount of force generated by the speaker.

Force-canceling speakers are one way that vibrations can be reduced. However, previous force-canceling speakers have not been tailored toward addressing the unique challenges of vehicle design, including the need to reduce cost and complexity, and to comply with demanding packaging constraints while delivering a high quality audio experience.

### SUMMARY

In an aspect, a force-canceling coaxial speaker system comprises: a speaker cabinet defining an interior; a first midrange speaker mounted inside the speaker cabinet; a second midrange speaker mounted inside the speaker cabinet, the first midrange speaker and the second midrange speaker having a common size; an acoustic aperture in the speaker cabinet, the acoustic aperture forming an opening from the interior having an area that is proportional to a speaker displaced volume of the first and second midrange speakers by a factor of about 80-160 by unit length; and a high-frequency transducer mounted adjacent the acoustic aperture.

Implementations can include any or all of the following features. The acoustic aperture has a substantially rectangular shape. Longer edges of the substantially rectangular shape are parallel with each of the first midrange speaker and the second midrange speaker. Each of the first midrange speaker and the second midrange speaker includes a diaphragm having a first substantially rectangular shape. The acoustic aperture has a second substantially rectangular shape. Longer edges of the second substantially rectangular shape are parallel with each of the first midrange speaker and the second midrange speaker. The longer edges of the second substantially rectangular shape are parallel with longer edges of the first substantially rectangular shape. The speaker cabinet has a substantially cylindrical shape. A diameter of the substantially cylindrical shape is about twice a height of the substantially cylindrical shape. Longer edges of the first substantially rectangular shape are parallel with a bottom wall of the speaker cabinet. The second substantially rectangular shape includes two opposing longer edges and two opposing shorter edges, wherein the high-frequency transducer abuts the two opposing longer edges, and wherein the opening is unobstructed between the high-frequency transducer and each of the two opposing shorter edges. The speaker cabinet has a positive terminal, and wherein each of the first midrange speaker and the second midrange speaker is connected to the positive terminal. Also the high-frequency transducer is connected to the positive terminal. The force-canceling coaxial speaker system further comprises a passive high-pass filter connected to the high-frequency transducer. The force-canceling coaxial speaker system further comprises an inductor connected to the high-frequency transducer. The acoustic aperture forms the opening to define a volume between the first midrange speaker and the second midrange speaker in the interior, and wherein the high-frequency transducer is positioned in the volume. The volume is further bounded by opposing side walls of the speaker cabinet, and by a bottom wall that is substantially perpendicular to the opposing side walls and to the first midrange speaker and the second midrange speaker. The first midrange speaker and the second midrange speaker are facing toward each other. The acoustic aperture is centered between the first midrange speaker and the second midrange speaker. The first midrange speaker and the second midrange speaker face toward each other in the interior. The first midrange speaker defines a first sealed enclosure in the interior, and wherein the second midrange speaker defines a second sealed enclosure in the interior separate from the first sealed enclosure. The high-frequency transducer is mounted in the acoustic aperture. The area of the opening of the acoustic aperture is at most equal to the common size.

### BRIEF DESCRIPTION OF DRAWINGS

FIG. 1 shows an example of a force-canceling coaxial speaker system with an acoustic aperture.

FIG. 2 shows a section through the force-canceling coaxial speaker system of FIG. 1.

FIG. 3 shows an example of a response diagram for a traditional coaxial speaker system.

FIG. 4 shows an example of a response diagram for a force-canceling coaxial speaker system with an acoustic aperture according to the present subject matter.

FIG. 5 shows an example of a comparison between the respective directivity indices of a traditional coaxial speaker system and a force-canceling coaxial speaker system with an acoustic aperture according to the present subject matter.

FIG. 6 shows an example of a schematic for a force-canceling coaxial speaker system with an acoustic aperture according to the present subject matter.

Like reference symbols in the various drawings indicate like elements.

### DETAILED DESCRIPTION

This document describes examples of systems and techniques relating to a speaker system that reduces the force or vibration being input to a vehicle trim or body structure. The speaker system can include an aperture that is acoustically tuned to achieve acoustic low-pass filtering functionality that is compatible with a high-frequency transducer to be mounted adjacent the aperture. The present subject matter can reduce the “buzz and rattle” of nearby/coexisting components that would otherwise be caused by speaker playback. The present subject matter can also lower the cost and complexity of the vehicle system and reduce the engineering time and effort in resolving coexistence problems in the vehicle system.

In some existing vehicles, coexistence of a speaker and the vehicle (e.g., an instrument panel, door, etc.) has resulted in buzz and rattle, and coloration of audio from speakers. In order to improve audio performance and reduce coexistence efforts one can use force-cancelling speakers (a speaker or speaker assembly where motional forces cancel, minimize or eliminate force or vibration transmitted to the mounting) according to the present subject matter. To realize a speaker associated with low force (at the mounting points) or low vibration (of the assembly) within the maximum applicable constraints, a coaxial speaker (e.g., of a cylindrical shape, such as with 100 mm diameter and 50 mm depth) can be used. Force cancelling speakers have several system advantages over traditional speakers for the automotive environment. The force input to the mounting positions of the speaker is reduced, providing less buzz, rattle of the vehicle structure and nearby components (i.e., improved coexistence). Losses due to unintended vibration of the structure or surfaces are reduced, which may allow reduced size in comparison to a traditional speaker.

In some implementations, a pair of higher aspect ratio transducers are used, e.g., similar to those used in TV and soundbar applications that are in production with mature, reliable and cost effective processes. The transducer diaphragms face toward or away from each other and the speaker includes a front port. A high-frequency transducer (e.g., a tweeter) is packaged adjacent (e.g., near or within) the front port.

Using a midrange driver type can provide advantages in addition to reduced force or vibration. The acoustic aperture can be reduced relative to the diaphragm area. The “grille” opening may be reduced by 50% or more giving greater flexibility to the vehicle design and styling. The acoustic “front port” may be advantageous in realizing a good crossover with the tweeter and help to achieve better directivity or evenness of radiation of sound in the vehicle.

As used herein, a vehicle is a machine that transports passengers or cargo, or both. A vehicle can have one or more motors. Examples of vehicles include, but are not limited to, cars, trucks, buses, motorcycles, and scooters. The number of wheels can differ between types of vehicles, and one or more (e.g., all) of the wheels can be used for propulsion of the vehicle. The vehicle can include a passenger compartment accommodating one or more persons.

As used herein, a speaker is a device with an electroacoustic transducer in which a voice coil and a connected diaphragm convert an electrical signal into sound. As used herein, a midrange speaker is a speaker for producing sound in the frequency range between about 100 hertz (Hz) and about 4 kilohertz (kHz). As used herein, a high-frequency transducer is a speaker for producing sound in the frequency range between about 1 kHz to at least about 20 kHz. A tweeter is an example of a high-frequency transducer as used herein.

As used herein, a diaphragm for a speaker can have any of multiple shapes including, but not limited to, a rectangular shape, oval shape, elliptical shape, or a circular shape. As used herein, a rectangular shape of a diaphragm may or may not have rounded corners. As used herein, a size of a speaker means the area of the speaker in a frontal view.

As used herein, an acoustic aperture from an interior of a speaker can have any of multiple shapes including, but not limited to, a rectangular shape, oval shape, a circular shape, or an irregular shape. As used herein, a rectangular shape of an acoustic aperture may or may not have rounded corners or rounded edges. A speaker system can have one or more acoustic apertures.

Examples described herein refer to a top, bottom, front, or rear. These and similar expressions identify things or aspects in a relative way based on an express or arbitrary notion of perspective. That is, these terms are illustrative only, used for purposes of explanation, and do not necessarily indicate the only possible position, direction, and so on.

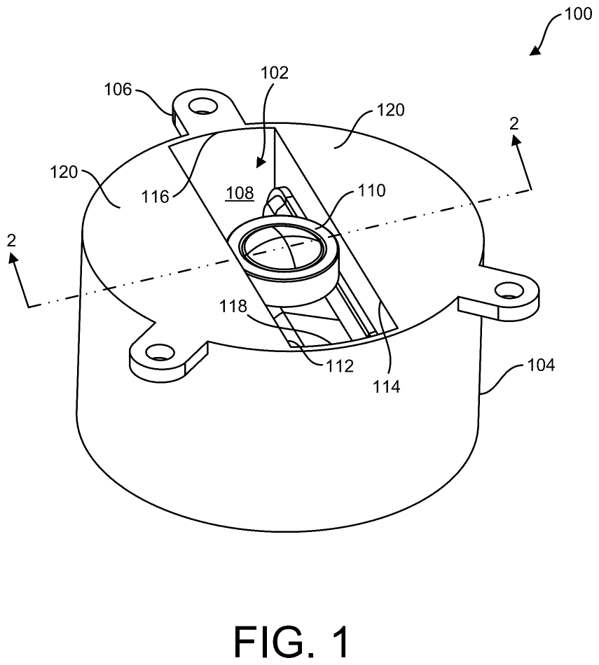

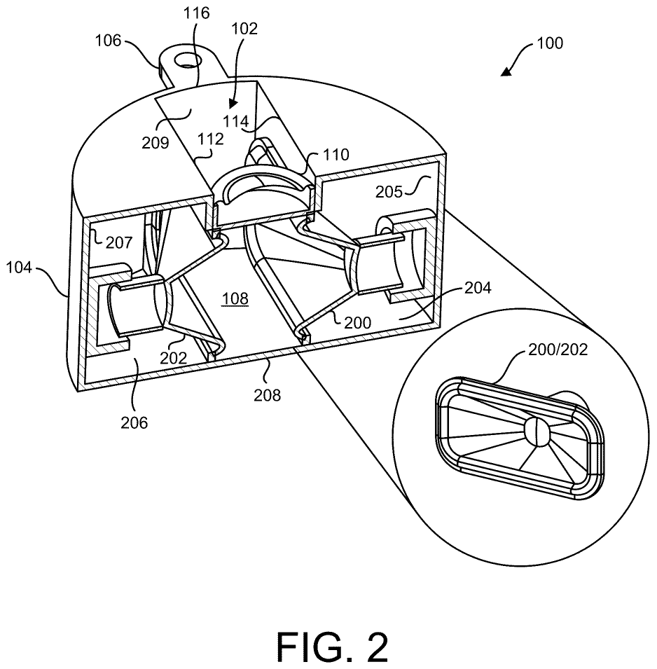

FIG. 1 shows an example of a force-canceling coaxial speaker system 100 with an acoustic aperture 102. FIG. 2 shows a section through the force-canceling coaxial speaker system 100 of FIG. 1. The force-canceling coaxial speaker system 100 can be used with one or more other examples described elsewhere herein. The force-canceling coaxial speaker system 100 can have one or more acoustic apertures.

The force-canceling coaxial speaker system 100 can be implemented in a speaker cabinet 104. The speaker cabinet 104 can be made from any of multiple materials including, but not limited to, metal or plastic. The speaker cabinet 104 can have any of a variety of forms depending on the surroundings where the force-canceling coaxial speaker system 100 is to be installed. In some implementations, the speaker cabinet 104 can have substantially cylindrical shape (e.g., as shown). For example, a diameter of the substantially cylindrical shape can be about twice a height of the substantially cylindrical shape. For illustrative purposes only, the speaker cabinet 104 can have a diameter of about 100 mm and a height of about 50 mm. The speaker cabinet 104 can include or be provided with one or more brackets 106 for mounting the force-canceling coaxial speaker system 100. For example, the bracket(s) 106 and the speaker cabinet 104 can be configured for an automative environment where one or more instances of the force-canceling coaxial speaker system 100 is to be installed in a vehicle.

The force-canceling coaxial speaker system 100 includes midrange speakers 200 and 202 and can have one or more sealed enclosures in its interior. Here, the midrange speaker 200 defines a sealed enclosure 204 in the interior of the speaker cabinet 104. For example, the rear of the midrange speaker 200 is mounted to an interior surface of a side wall 205 of the speaker cabinet 104 inside the sealed enclosure 204, and a diaphragm of the midrange speaker 200 faces into a volume 108 in the interior of the speaker cabinet 104 that is defined at least in part by the acoustic aperture 102.

Here, the midrange speaker 202 defines a sealed enclosure 206 in the interior of the speaker cabinet 104, the sealed enclosure 206 being separate from the sealed enclosure 204. For example, the rear of the midrange speaker 202 is mounted to an interior surface of a side wall 207 of the speaker cabinet 104 inside the sealed enclosure 206, and a diaphragm of the midrange speaker 202 faces into the volume 108.

The midrange speakers 200 and 202 face toward or away from each other in the interior of the speaker cabinet 104. For example, such arrangements provide force canceling when the midrange speakers 200 and 202 are driven by the same signal. The midrange speakers 200 and 202 can have a common size with each other (i.e., have diaphragms of the same size). In some implementations, each of the midrange speakers 200 and 202 has a diaphragm of a substantially rectangular shape (e.g., as shown). The shape of the midrange speakers 200 and 202 (e.g., their aspect ratio, or the size of a non-rectangular form such as a circular speaker) can be chosen to facilitate an overall form factor of the force-canceling coaxial speaker system 100. For example, the midrange speakers 200 and 202 can be installed in the speaker cabinet 104 so that longer edges of the substantially rectangular shape of the midrange speakers 200 and 202 are parallel with a bottom wall 208 of the speaker cabinet 104.

The acoustic aperture 102 is an example of the one or more acoustic apertures of the force-canceling coaxial speaker system 100. The acoustic aperture 102 forms an opening from the interior of the speaker cabinet 104 to guide at least the sound generated by the midrange speakers 200 and 202. The acoustic aperture 102 can have any shape. In some implementations, the acoustic aperture 102 can have a substantially rectangular shape (e.g., as shown). Longer edges of the substantially rectangular shape of the acoustic aperture 102 can be parallel with each of the midrange speakers 200 and 202.

The opening formed by the acoustic aperture 102 has an area that is at most equal to the common size of the diaphragms of the midrange speakers 200 and 202. The reduced opening defined by the acoustic aperture 102, combined with the volume of air behind the acoustic aperture 102, can act as an acoustic low-pass filter for the sound generated by the midrange speakers 200 and 202. This can facilitate a less complex design of the force-canceling coaxial speaker system 100, for example as described below. The acoustic aperture 102 can be centered between the diaphragms of the midrange speakers 200 and 202. In some implementations, the acoustic aperture 102 is centered on a diameter of the substantially cylindrical shape of the speaker cabinet 104. In other implementations, the acoustic aperture 102 can have an asymmetrical position where it is not centered between the diaphragms of the midrange speakers 200 and 202.

The force-canceling coaxial speaker system 100 can include a high-frequency transducer 110 mounted adjacent the acoustic aperture 102 in a coaxial configuration. The high-frequency transducer 110 can be positioned within or near the acoustic aperture 102. In some implementations, the high-frequency transducer 110 is positioned in the volume 108 between the midrange speakers 200 and 202. For example, the volume 108 can be further bounded by opposing side walls of the speaker cabinet 104 (here a side wall 209 and another opposing side wall facing toward the side wall 209), and by the bottom wall 208. That is, the bottom wall 208 is here substantially perpendicular to the opposing side walls and to the first midrange speaker and the second midrange speaker.

The substantially rectangular shape of the acoustic aperture 102 can include longer edges 112 and 114 that oppose each other, and shorter edges 116 and 118 that oppose each other. That is, the shorter edge 118 can be formed by the other opposing side wall that faces toward the side wall 209. In some implementations, the midrange speakers 200 and 202 have a substantially rectangular shape and the longer edges 112 and 114 can be parallel with the respective longer edges of the midrange speakers 200 and 202. In some implementations, the high-frequency transducer 110 can abut at least the longer edges 112 and 114. For example, the high-frequency transducer 110 may not be abutting the shorter edges 116 and 118 such that the opening from the interior is unobstructed between the respective sides of the high-frequency transducer 110 and each of the shorter edges 116 and 118. In other implementations, the high-frequency transducer 110 can be positioned elsewhere than within the acoustic aperture 102 yet adjacent to the opening thereof so that the speaker system is coaxial. For example, the high-frequency transducer 110 can be positioned on or at a surface 120 that can be characterized as a front surface of the force-canceling coaxial speaker system 100.

The above examples illustrate that a force-canceling coaxial speaker system (e.g., the force-canceling coaxial speaker system 100) can include: a speaker cabinet (e.g., the speaker cabinet 104) defining an interior; a first midrange speaker (e.g., the midrange speaker 200) mounted inside the speaker cabinet; a second midrange speaker (e.g., the midrange speakers 202) mounted inside the speaker cabinet, the first midrange speaker and the second midrange speaker having a common size (e.g., as shown); an acoustic aperture (e.g., the acoustic aperture 102) in the speaker cabinet, the acoustic aperture forming an opening from the interior that is at most equal to the common size; and a high-frequency transducer (e.g., the high-frequency transducer 110) mounted adjacent the acoustic aperture.

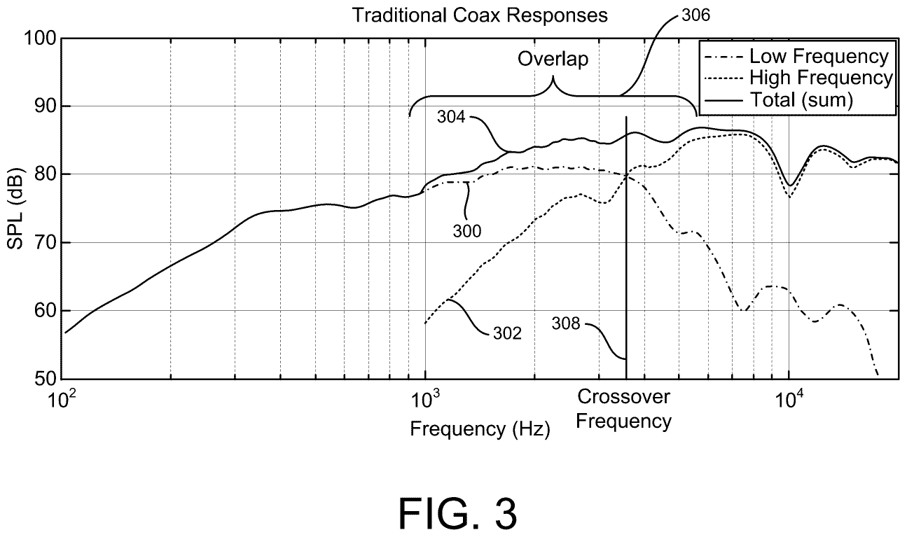

FIG. 3 shows an example of a response diagram for a traditional coaxial speaker system. That is, the responses shown in the diagram are from a coaxial speaker that does not have an acoustic aperture according to the present subject matter. The diagram shows sound pressure level (SPL) on the vertical axis in decibel (dB) and frequency on the horizontal axis in hertz (Hz). The diagram includes a graph 300 of the SPL for a low-frequency speaker (e.g., a midrange speaker). The diagram includes a graph 302 of the SPL for a high-frequency speaker (e.g., a tweeter) coaxial with the low-frequency speaker. The diagram includes a graph 304 of the total SPL (i.e., the sum of the graphs 300 and 302). The plot is bounded on the left at 100 Hz due to low signal-to-noise ratio. Similarly, the graph 302 is here bounded to the left to 1 kHz.

The graphs 300-304 show an overlap range 306 corresponding to the frequency range where both the low-frequency speaker and the high-frequency speaker are contributing to the audio output. Here, the overlap range 306 is the range of about 1 kHz-6 kHz, corresponding to about 2.6 octaves. A crossover frequency 308 where the graphs 300-302 intersect is about 3.6 kHz in this diagram.

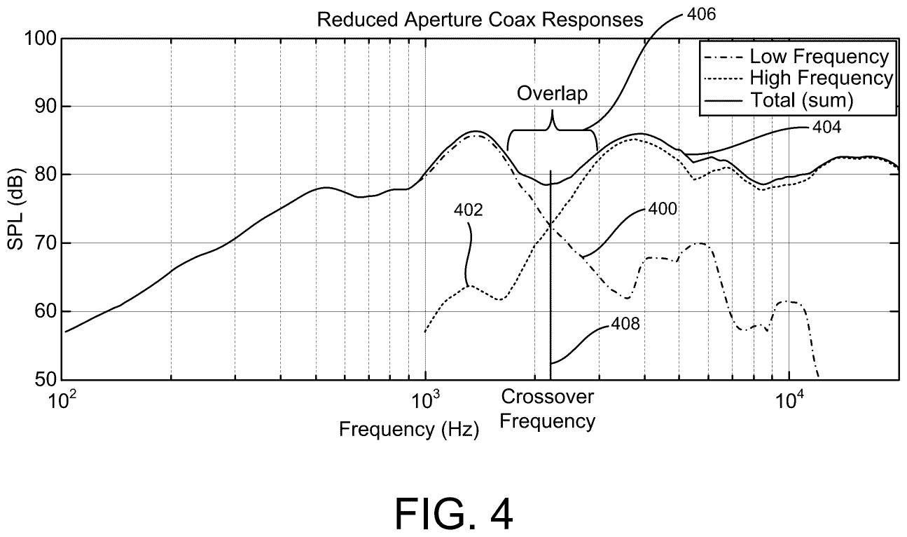

FIG. 4 shows an example of a response diagram for a force-canceling coaxial speaker system with a tuned acoustic aperture according to the present subject matter. The acoustic aperture is shaped so that the Helmholz resonance is tuned to achieve acoustic low-pass filtering functionality that is compatible with the high-frequency transducer being used in the speaker system. The acoustic tuning involves designing the acoustic aperture to have an opening that acts as a low-pass filter given the volume of the interior. The aperture area of the force-canceling coaxial speaker system meets the following requirement:

A=C*S_{d}*Xₘₐₓ,

where A is the aperture area, C is a factor that ranges between about 80 and about 160 per unit length, S_{d} is the cumulative area of the diaphragms of the midrange speakers, and Xₘₐₓ is the maximum excursion of each of the midrange speakers. As such, the product of S_{d} and Xₘₐₓ can be referred to as the speaker displaced volume and the aperture area A is proportional to the speaker displaced volume by the factor C.

In the response diagram, the speaker system is characterized as having a reduced aperture, meaning that the size of the acoustic aperture has been selected to provide the low-pass filter functionality. In some implementations, the acoustic aperture has a size that is at most equal to the size of each of the low-frequency speakers. The diagram shows SPL on the vertical axis and frequency on the horizontal axis. The diagram includes a graph 400 of the SPL for a pair of low-frequency speakers (e.g., midrange speakers) facing toward or away from each other. The diagram includes a graph 402 of the SPL for a high-frequency speaker (e.g., a tweeter) coaxial with the low-frequency speakers. The diagram includes a graph 404 of the total SPL (i.e., the sum of the graphs 400 and 402). The plot is bounded on the left at 100 Hz due to low signal-to-noise ratio. Similarly, the graph 402 is here bounded to the left to 1 kHz.

The graphs 400-404 show an overlap range 406 corresponding to the frequency range where both the low-frequency speakers and the high-frequency speaker are contributing to the audio output. Here, the overlap range 406 is the range of about 1.7 kHz-2.8 kHz, corresponding to about 0.72 octaves. That is, the overlap range 406 of the speaker system according to the present subject matter is narrower than the overlap range 306 of the traditional coaxial speaker system. A crossover frequency 408 where the graphs 400-402 intersect is about 2.1kHz in this diagram. That is, the crossover frequency 408 of the speaker system according to the present subject matter is lower than the crossover frequency 308 of the traditional coaxial speaker system.

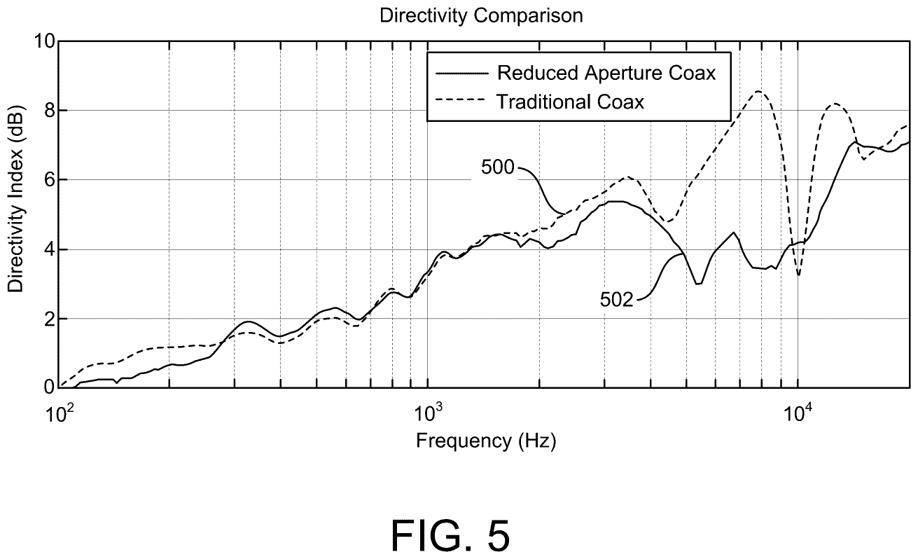

FIG. 5 shows an example of a comparison between the respective directivity indices of a traditional coaxial speaker system and a force-canceling coaxial speaker system with an acoustic aperture according to the present subject matter. The diagram shows directivity indices on the vertical axis in dB and frequency on the horizontal axis in Hz. The diagram includes a graph 500 for the traditional coaxial speaker system, and a graph 502 for the force-canceling coaxial speaker system with the acoustic aperture.

The diagram shows that below about 5 kHz the directivity of the force-canceling coaxial speaker system with the acoustic aperture (graph 502) is lower and smoother than the directivity of the traditional coaxial speaker system (graph 500). This is due to a lower crossover point (e.g., the crossover frequency 408 of FIG. 4) and reduced overlap range (e.g., the overlap range 406 of FIG. 4) of the force-canceling coaxial speaker system with the acoustic aperture.

The diagram also shows that above about 5 kHz the directivity of the force-canceling coaxial speaker system with the acoustic aperture is additionally improved due to the smaller aperture, because less sound diffracts back to the surface and is reflected.

Many traditional coaxial speaker systems use two channels each having an amplifier and digital signal processor. This can allow such systems to achieve low crossover, reduced overlap, and low and smooth directivity. If such systems were to instead use a single amplifier channel, they may require multiple crossover filter components. For example, each of a low-frequency speaker and a high-frequency speaker may have a respective inductor and capacitor, for a total of at least four crossover filter components. The use of multiple crossover filter components adds to the cost and complexity of manufacturing. By contrast, a force-canceling coaxial speaker system with an acoustic aperture according to the present subject matter can enable use of a single amplifier channel, and can do so with fewer crossover filter components, for example as will now be described.

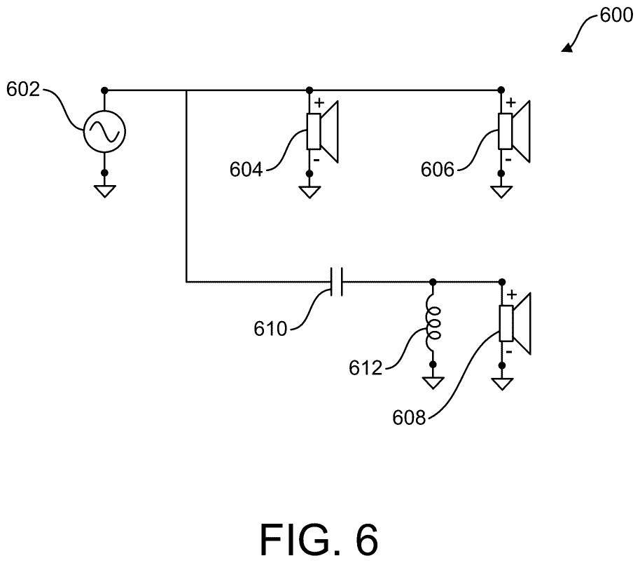

FIG. 6 shows an example of a schematic 600 for a force-canceling coaxial speaker system with an acoustic aperture according to the present subject matter. The schematic 600 can be used with one or more other examples described elsewhere herein. The schematic 600 includes a sound source 602. For example, the sound source 602 can include an amplifier that is part of an infotainment system in a vehicle. The sound source 602 has a positive terminal connected to a remainder of the schematic 600, and a negative terminal connected to ground.

The schematic 600 includes midrange speakers 604 and 606 which have a common size and are mounted to face toward or away from each other. Each of the respective positive terminals of the midrange speakers 604 and 606 is connected to the positive terminal of the sound source 602. Each of the respective negative terminals of the midrange speakers 604 and 606 is connected to ground.

The schematic 600 includes a high-frequency transducer 608. In some implementations, the high-frequency transducer 608 is mounted in an acoustic aperture. For example, the acoustic aperture can be centered between the midrange speakers 604 and 606. A positive terminal of the high-frequency transducer 608 is connected directly or indirectly to the positive terminal of the sound source 602. A negative terminal of the high-frequency transducer 608 is connected to ground. That is, the speaker cabinet (e.g., the speaker cabinet 104 of FIG. 1) can include a positive terminal to be connected to the positive terminal of the sound source 602. It is therefore feasible to run the midrange speakers 604 and 606 and the high-frequency transducer 608 using a single amplifier channel.

The schematic 600 can include a passive high-pass filter 610 connected to the high-frequency transducer 608. For example, the passive high-pass filter 610 can include a capacitor. In some implementations, the passive high-pass filter 610 is the only crossover filter component used by the schematic 600, meaning that the number of crossover filter components has been reduced from four to one. The schematic 600 can, in some implementations, also include an inductor 612 connected between the positive terminal of the high-frequency transducer 608 and ground. Even if the inductor 612 is included, the schematic 600 reduces the number of crossover filter components from four to two compared to the traditional coaxial speaker system. As discussed above with reference to FIGS. 4 and 5, a force-canceling coaxial speaker system with an acoustic aperture according to the present subject matter can achieve a low crossover point, a low overlap range, and low and smooth directivity.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one”.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described. The following listing of claims will replace all prior versions and listings of claims in the application. The status of each claim is indicated. No new matter is added by this amendment.

1. A force-canceling coaxial speaker system comprising:
a speaker cabinet defining an interior;
a first midrange speaker mounted inside the speaker cabinet;
a second midrange speaker mounted inside the speaker cabinet, the first midrange speaker and the second midrange speaker having a common size;
an acoustic aperture in the speaker cabinet, the acoustic aperture forming an opening from the interior having an area that is proportional to a speaker displaced volume of the first and second midrange speakers by a factor of about 80-160 by unit length; and
a high-frequency transducer mounted adjacent the acoustic aperture.

2. The force-canceling coaxial speaker system of claim 1, wherein the acoustic aperture has a substantially rectangular shape.

3. The force-canceling coaxial speaker system of claim 2, wherein longer edges of the substantially rectangular shape are parallel with each of the first midrange speaker and the second midrange speaker.

4. The force-canceling coaxial speaker system of claim 1, wherein each of the first midrange speaker and the second midrange speaker includes a diaphragm having a first substantially rectangular shape.

5. The force-canceling coaxial speaker system of claim 4, wherein the acoustic aperture has a second substantially rectangular shape.

6. The force-canceling coaxial speaker system of claim 5, wherein longer edges of the second substantially rectangular shape are parallel with each of the first midrange speaker and the second midrange speaker.

7. The force-canceling coaxial speaker system of claim 6, wherein the longer edges of the second substantially rectangular shape are parallel with longer edges of the first substantially rectangular shape.

8. The force-canceling coaxial speaker system of claim 4, wherein the speaker cabinet has a substantially cylindrical shape.

9. (canceled)

10. The force-canceling coaxial speaker system of claim 4, wherein longer edges of the first substantially rectangular shape are parallel with a bottom wall of the speaker cabinet.

11. The force-canceling coaxial speaker system of claim 5, wherein the second substantially rectangular shape includes two opposing longer edges and two opposing shorter edges, wherein the high-frequency transducer abuts the two opposing longer edges, and wherein the opening is unobstructed between the high-frequency transducer and each of the two opposing shorter edges.

12. The force-canceling coaxial speaker system of claim 1, wherein the speaker cabinet has a positive terminal, and wherein each of the first midrange speaker and the second midrange speaker is connected to the positive terminal.

13. The force-canceling coaxial speaker system of claim 12, wherein also the high-frequency transducer is connected to the positive terminal.

14. The force-canceling coaxial speaker system of claim 13, further comprising a passive high-pass filter connected to the high-frequency transducer.

15. The force-canceling coaxial speaker system of claim 12, further comprising an inductor connected to the high-frequency transducer.

16. The force-canceling coaxial speaker system of claim 1, wherein the acoustic aperture forms the opening to define a volume between the first midrange speaker and the second midrange speaker in the interior, and wherein the high-frequency transducer is positioned in the volume.

17. The force-canceling coaxial speaker system of claim 16, wherein the volume is further bounded by opposing side walls of the speaker cabinet, and by a bottom wall that is substantially perpendicular to the opposing side walls and to the first midrange speaker and the second midrange speaker.

18. (canceled)

19. The force-canceling coaxial speaker system of claim 1, wherein the acoustic aperture is centered between the first midrange speaker and the second midrange speaker.

20. (canceled)

21. The force-canceling coaxial speaker system of claim 1, wherein the first midrange speaker defines a first sealed enclosure in the interior, and wherein the second midrange speaker defines a second sealed enclosure in the interior separate from the first sealed enclosure.

22. The force-canceling coaxial speaker system of claim 1, wherein the high-frequency transducer is mounted in the acoustic aperture.

23. The force-canceling coaxial speaker system of claim 1, wherein the area of the opening of the acoustic aperture is at most equal to the common size.
